(19) United States
(12) Patent Application Publication
(10) Pub. No.: US 2003/0108471 A1
(43) Pub. Date: Jun. 12, 2003

(54) Method for removing carbon monoxide from a hydrogen-rich gas mixture by selective oxidation

(75) Inventors: Chiou-Hwang Lee, Hsinchu (TW); Chiung-Hui Huang, Hsinchu (TW); Li-Ping Chu, Hsinchu (TW)

Correspondence Address: BACON & THOMAS, 4th Floor, 625 Slaters Lane, Alexandria, VA, 22314, US

(73) Assignee: Industrial Technology Research Institute, Hsinchu (TW)

(21) Appl. No.: 10/078,664

(22) Filed: Feb. 21, 2002

(30) Foreign Application Priority Data
Dec. 12, 2001 (TW) 90130827

(51) Int. Cl. B01D 53/62

(52) U.S. Cl. 423/247

(57) ABSTRACT

The present invention discloses a catalyst useful in selective oxidation of carbon monoxide (CO) contained in a hydrogen-rich reformate gas. The catalyst is a zeolite carrying Pt, Ru or alloys thereof. Pt or Ru is deposited on the zeolite by incipient wetness impregnation with an aqueous solution. The reformate gas having a reduced CO concentration can be introduced to a fuel cell as a fuel.

### FIELD OF THE INVENTION

The present invention provides a catalyst useful in selective oxidation of carbon monoxide (CO) contained in a hydrogen-rich reformate gas. The reformate gas having a reduced CO concentration can be introduced to a fuel cell as a fuel.

### BACKGROUND OF THE INVENTION

The development of the polymer electrolyte membrane fuel cell (PEMFC) is an important research and development topic in the automotive industry and the electric power industry. A PEM fuel cell uses the electrochemical reaction of H₂+1/2O₂→H₂O to generate a clean electric power. The hydrogen source thereof can be a pressured hydrogen cylinder, a hydrogen storage alloy tank, or H₂-rich gases generated from hydrocarbons by reforming reactions. Due to the lack of a complete infrastructure for hydrogen supply, the first two hydrogen sources need a long promotional period in the near future. Thus, hydrogen gas generated from hydrocarbons (e.g. methanol, natural gas, LPG and gasoline, etc.) through the reforming reactions is an ideal short term solution. However, the H₂-rich gases generated from hydrocarbons by reforming reactions (e.g. autothermal reforming or steam reforming), and high/low temperature water gas-shift reaction (WGS), still contain 0.5˜2% of carbon monoxide (CO). Since CO can poison the anode electrocatalyst (Pt/C and Pt—Ru/C) of a PEMFC, the output power of the cell will decrease conspicuously. Thus, CO concentration in the reformate gas should be lowered to below 100 ppm, or even below 10 ppm.

A selective oxidation method can be used to reduce the CO concentration in the hydrogen-rich reformate gas. Reactors and reaction processes with suitable CO-oxidation selectivity have been disclosed in a few patents. Japanese patent publication No. JP9-35734 discloses catalysts formed by depositing Pt or Ru on Al₂O₃ or SiO₂ are useful in the CO selective oxidation reaction. However, the selectivity of the CO oxidation reaction of these catalysts is still not ideal, and the reaction temperature thereof is within a narrow range, and thus there is still a room to be improved.

Japanese Professor Watanabe in his article published in the Applied Catalysis A: General 159 (1997) 159-169 utilizes a Pt/zeolite catalyst in the CO selective oxidation reaction of a hydrogen-rich reformate gas. Experimental data show that the Pt/zeolite catalyst has a CO oxidation selectivity far higher than that of Pt/Al₂O₃ catalyst. The CO oxidation selectivity of Pt/Zeolite is also found dependent on the type of the zeolite used. The CO oxidation selectivity of the catalysts are in the order of Pt/A-Zeolite>Pt/Mordenite>Pt/X-Zeolite>Pt/Al₂O₃. Watanabe prepares said Pt/Zeolite catalysts by using an aqueous solution of Pt(NH₃)₄Cl₂.H₂O to perform an ion exchange with a Na-Zeolite.

U.S. Pat. No. 5,702,838 (assigned to MATSUSHITA Co., Japan) discloses a Pt/A-Zeolite catalyst prepared by an inpregnation method or an ion exchange method, which has a good CO oxidation selectivity in a hydrogen-rich reformate gas. U.S. Pat. No. 5,955,395 (assigned to Mercedes-Benz Chrysler Co.) discloses a Pt/NaY-Zeolite catalyst having a high CO oxidation selectivity, wherein the Pt/NaY-Zeolite catalyst is prepared by an ion exchange method.

Example 1 in the abovementioned U.S. Pat. No. 5,702,838 discloses that the Pt/A-Zeolite catalyst prepared by an ion exchange method had a slightly better CO oxidation selectivity in a hydrogen-rich reformate gas than the one prepared by an impregnation method.

### SUMMARY OF THE INVENTION

One objective of the present invention is to provide a catalyst that can be used in the selective oxidation of CO in a hydrogen-rich mixture gas. Said catalyst is easy to be prepared and has a high CO oxidation selectivity. Another objective of the present invention is to provide a method for removing CO from a hydrogen-rich mixture gas by a selective oxidation.

In order to achieve the abovementioned objectives, the present invention provides a method for removing CO from a hydrogen-rich mixture gas by a selective oxidation, which comprises the following steps:

a) preparing a zeolite catalyst carrying Pt or Ru;

b) flowing a CO-containing hydrogen-rich mixture gas and an oxygen-containing gas through said zeolite catalyst carrying Pt or Ru;

wherein the process of preparing said zeolite catalyst carrying Pt or Ru in Step (a) comprises the following steps:

a1) mixing a zeolite with an aqueous solution containing Pt ions or Ru ions in an amount of said aqueous solution so that said zeolite is subjected to an incipient wetness impregnation, provided that said zeolite is not A-zeolite; and

a2) heating said incipient wetness impregnated zeolite so that only Pt ions or Ru ions in said aqueous solution are deposited to said zeolite.

Preferably, the amount of said aqueous solution in Step (a1) used enables said zeolite to be incipient wetness impregnated with 0.5-5.0 wt % of Pt ions or Ru ions based on the weight of the zeolite.

Preferably, said zeolite in Step (a1) is a Y-zeolite, a ZSM zeolite or a Mordenite zeolite, and more preferably, is a Y-zeolite.

Preferably, the heating in Step (a2) comprises drying said incipient wetness impregnated zeolite at 100-120° C., and calcining said dried zeolite at 400-600° C.

Preferably, said CO-containing hydrogen-rich mixture gas and said oxygen-containing gas in Step (b) has a temperature of 50-250° C.

Preferably, said CO-containing hydrogen-rich mixture gas in Step (b) is a hydrogen-rich reformate gas obtained by reforming a hydrocarbon, and a hydrogen-rich reformate gas having a reduced CO concentration exiting from said zeolite catalyst carrying Pt or Ru is introduced into a fuel cell.

Preferably, said zeolite catalyst carrying Pt or Ru in Step (b) is surrounded by an atmosphere having a molar ratio of oxygen to CO of 0.5˜2.

### BRIEF DESCRIPTION OF THE DRAWINGS

FIG. 1 is a plot of the CO conversion of the catalysts vs. the temperature of the catalyst bed when the molar ratio of CO/O₂ in the reactant gas is 2, wherein the catalyst prepared in Example 1 of the present invention is represented by a black dot; the catalyst prepared in Example 2 is represented by a hollow dot; the catalyst prepared in Example 3 is represented by a black triangle; and the catalyst prepared in Control Example 1 is represented by a black rhombus.

FIG. 2 is a plot of the CO conversion of the catalysts vs. the temperature of the catalyst bed when the molar ratio of CO/O₂ in the reactant gas is 1, wherein the catalyst prepared in Example 1 of the present invention is represented by a black dot; the catalyst prepared in Example 2 is represented by a hollow square; the catalyst prepared in Control Example 1 is represented by a black rhombus; and the catalyst prepared in Control Example 2 is represented by a black triangle

FIG. 3 is a plot of the CO conversion of the catalysts vs. the inlet temperature of the reactant gases when the molar ratio of CO/O₂ of the reactant gas is 1, wherein the honeycomb catalyst prepared in Example 4 of the present invention is represented by a black square; the honeycomb catalyst prepared in Example 5 is represented by a black dot; and the honeycomb catalyst prepared in Example 6 is represented by a hollow square.

### DETAILED DESCRIPTION OF THE PREFERRED EMBODIMENTS

According to a preferred embodiment of the present invention a method for removing CO from a CO-containing hydrogen-rich reformate gas is disclosed. The hydrogen-rich reformate gas and an oxygen-containing gas are passed through a zeolite catalyst carrying Pt or Ru, wherein CO is selectively oxidized into carbon dioxide in the presence of said catalyst at a temperature of 50˜250° C. and a molar ratio of oxygen to CO of 0.5˜2. A desirable catalyst shall have a CO conversion close to 100%, and CO oxidation selectivity close to 100%. The former is defined as ([CO concentration in the feed]−[CO concentration in the product])/[CO concentration in the feed]×100%; and the later is defined as ([CO₂ concentration in the product]−[CO₂ concentration in the feed])×0.5/([O₂ concentration in the feed]−[O₂ concentration in the product])×100%.

Said hydrogen-rich reformate gas typically is formed by reforming a hydrocarbon; and said oxygen-containing gas typically is air. Said hydrogen-rich reformate gas having a reduced CO concentration exiting from said zeolite catalyst carrying Pt or Ru can be introduced into an anode of a fuel cell. Further details can be found in U.S. Pat. No. 5,702,838, which is incorporated herein by reference.

The present invention can be further understood by the following examples which are for illustrative purposes only and not for limiting the scope of the present invention.

### EXAMPLE 1

10 g of an H-type Y-zeolite (HY-zeolite) (particle size 30˜40 meshes) was used to prepare a catalyst by incipient wetness impregnation. A suitable amount (about 8 ml) of a Pt(NH₃)₂(NO₂)₂ nitric acid aqueous solution (containing 0.3 g of Pt) was dripped onto said HY-zeolite particles. The incipient wetness impregnated HY-zeolite partilces were dried at 120° C. for 8 hours, and then calcined at 500° C. for 2 hours. The resulting Pt/HY-zeolite catalyst contains about 3 wt % of Pt.

### EXAMPLE 2

The procedures of Example 1 were repeated to produce a Pt/HY-zeolite catalyst containing about 1 wt % of Pt by using a Pt(NH₃)₂(NO₂)₂ nitric acid aqueous solution containing 0.1 g of Pt.

### EXAMPLE 3

10 g of an ZSM-5 zeolite (particle size 30˜40 meshes) was used to prepare a catalyst by incipient wetness impregnation. A suitable amount (about 6 ml) of a Pt(NH₃)₂(NO₂)₂ nitric acid aqueous solution (containing 0.3 g of Pt) was dripped onto said ZSM-5 zeolite particles. The incipient wetness impregnated ZSM-5 zeolite particles were dried at 120° C. for 8 hours, and then calcined at 500° C. for 2 hours. The resulting Pt/ZSM-zeolite catalyst contains about 3 wt % of Pt.

### Control Example 1

10 g of a γ-Al₂O₃ was used to prepare a catalyst by incipient wetness impregnation. A suitable amount (about 14 ml) of a Pt(NH₃)₂(NO₂)₂ nitric acid aqueous solution (containing 0.3 g of Pt) was dripped onto said catalyst particles. The incipient wetness impregnated γ-Al₂O₃ was dried at 120° C. for 8 hours, and then calcined at 500° C. for 2 hours. The resulting Pt/Al₂O₃ catalyst contains about 3 wt % of Pt. Prior to be used in a selective oxidation reaction, the catalyst was activated by introducing with a 5% H₂/N₂ gas mixture at 400° C. for reduction for one hour.

### Control Example 2

0.903 g of Pt(NH₃)₂Cl₂.H₂O (containing 54.4 wt. % of Pt) was dissolved in 1000 ml of distilled water. 50 g of a HY-zeolite (particle size 30˜40 meshes) was placed in the resulting Pt aqueous solution. The mixture was agitated for 24 hours, filtered, and washed with deionized water for removing the chlorine ions on the surface of the zeolite. Then, the zeolite was dried at 120° C. for 8 hours, and then calcined at 500° C. for 2 hours. The resulting Pt/Y-zeolite catalyst has a Pt concentration of 1 wt %. Prior to be used in a selective oxidation reaction, the catalyst was activated by introduced a 5% H₂/N₂ gas mixture at 400° C. for reduction for one hour.

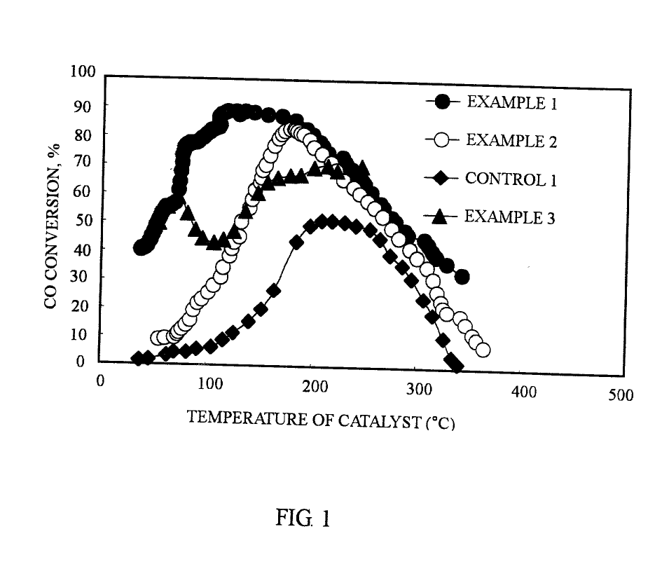

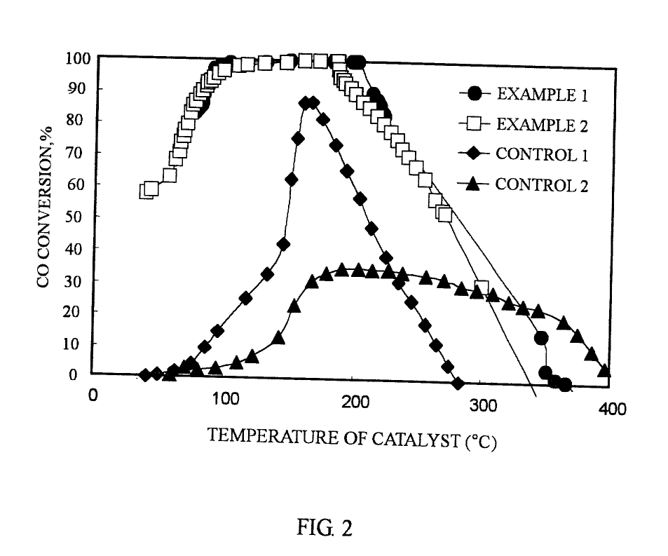

The conventional fixed-bed catalytic reactor was used for testing the activity of the catalysts. 1.5 g of the catalyst (with a particle size of 30˜40 meshes) was loaded into a stainless reaction tube (having an outside diameter of ⅜ inch). The reaction gas contained 40% H₂, 20% CO₂, 10% H₂O, 2% CO, 1% (or 2%) O₂, and the balance of N₂. The flowrate of the reaction gas was 1000 cc/min. FIG. 1 and FIG. 2 show plots of the CO conversion vs. the temperature of the catalyst bed of the catalysts prepared in Examples 1˜3 and Control Examples 1˜2, wherein FIG. 1 shows the results of the molar ratio of CO/O₂=2 and FIG. 2 shows the results of the molar ratio of CO/O₂=1.

It can be seen from FIG. 1 that the CO conversions of the catalysts prepared in Examples 1˜3 are significantly higher than that of the catalyst prepared in Control Example 1. Moreover, the Pt/HY-zeolite catalyst (with a Pt concentration of 3 wt % and prepared by an incipient wetness impregnation) prepared in Example 1 has the highest CO conversion and a broader operational temperature range than that of the Pt/HY-zeolite catalyst (with a Pt concentration of 1 wt %) prepared in Example 2. Even though the CO conversion of the Pt/ZSM catalyst of Example 3 is not as good as that of the Pt/HY-zeolite catalysts of Examples 1 and 2, its maximum CO conversion still can reach 70% which is conspicuously better than that of the Pt/Al₂O₃ of Control Example 1. Furthermore, the operational temperature range of the Pt/ZSM catalyst is significantly better than that of thet/Al₂O₃ catalyst.

FIG. 2 shows the results of the molar ratio of CO/O₂=1. It can be seen from the data in FIG. 2 that the highest CO conversion reaches 100% for the Pt (3 wt %)/HY-zeolite catalyst and the Pt (1 wt %)/HY-zeolite catalyst prepared in Examples 1 and 2. The reaction curves for these two catalysts are similar. Furthermore, the CO conversions of the Pt/HY-zeolite catalysts are close to 100% at 120˜200° C. The experimental data of FIG. 1 and FIG. 2 also demonstrate that the CO conversion of the catalysts of the present invention can be increased by lowering the molar ratio of CO/O₂. Meanwhile, the experimental data also show that the CO conversions of the Pt—HY-zeolite catalysts prepared in Examples 1˜3 according to the present invention are significantly better than the catalysts prepared in Control Examples 1-2, e.g. Pt/Al₂O₃ catalyst, and the ion-exchanged Pt/HY-zeolite catalyst.

### EXAMPLE 4

To 18 g of the Pt/HY-zeolite catalyst prepared in Example 1 with 3.2 g alumina sol was added. The solid content of the mixture was adjusted by adding a suitable amount of water. After grinding, the viscosity of the resulting slurry was adjusted. Next, the slurry was coated on a ceramic honeycomb support having a volume of 6.3 cc and a cell density of 400 cells/in². The amount of the catalyst coated was about 0.8 g/unit. Subsequently, the catalyst/support was dried at 120° C. for 4 hours, and calcined at 450° C. for 2 hours.

### EXAMPLE 5

To 18 g of a Y-zeolite powder 3.2 g of an alumina sol was added. The solid content of the mixture was adjusted by adding a suitable amount of water. After grinding, the viscosity of the resulting slurry was adjusted. Next, the slurry was coated on a ceramic honeycomb support having a volume of 6.3 cc and a cell density of 400 cells/in². The amount of the zeolite coated was about 0.8 g/unit. Subsequently, the zeolite/support was dried at 120° C. for 4 hours, and calcined at 450° C. for 2 hours. The catalyst was then impregnated with a Pt(NH₃)₂(NO₂)₂ nitric acid aqueous solution, and then dried at 120° C. for 4 hours, and calcined at 450° C. for 2 hours. The resulting catalyst has a Pt content of 0.02 g/unit.

### EXAMPLE 6

The procedures of Example 4 were repeated to prepared a honeycomb Pt/HY-zeolite catalyst, except that a metal honeycomb support having a volume of 6.3 cc and a cell density of 300 cells/in² was used to replace the ceramic honeycomb support. The amount of the catalyst coated was also controlled to be about 0.8 g/unit.

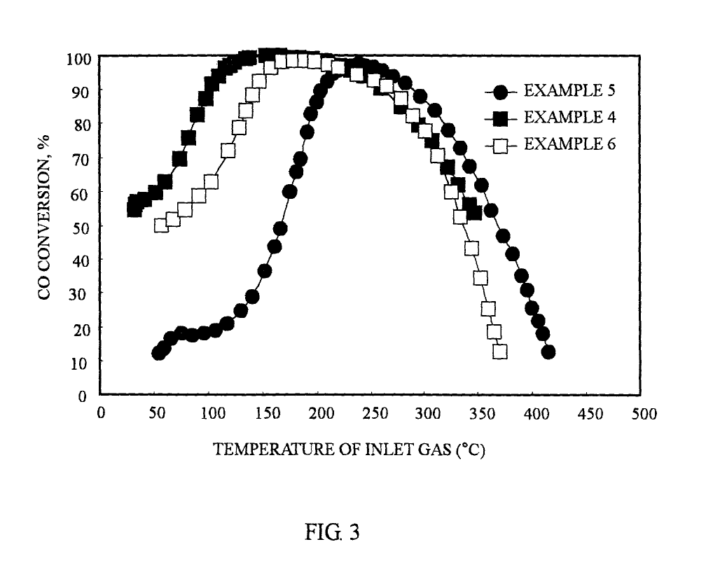

The conventional fixed-bed catalytic reactor was used for testing the activity of the catalysts. The honeycomb catalysts (diameter 2 cm×2 cm) prepared in Examples 4˜6 were separately loaded into a quartz reaction tube having an outside diameter of 1 inch. The reaction gas contained 40% H₂, 20% CO₂, 10% H₂O, 2% CO, 2% O₂, and the balance of N₂. The flowrate of the reaction gas was 600 cc/min. The results are shown in FIG. 3. The experimental data of FIG. 3 show that the catalysts prepared by coating the Pt/HY-zeolite catalyst powder of the present invention on a honeycomb support (Examples 4 and 6), have a CO conversion of higher than 95%. Furthermore, the CO conversion is higher when the cell density of the honeycomb support is higher. For example, the CO conversion of the catalyst prepared in Example 4 (cell density: 400 cells/in²) was higher than that of the catalyst prepared in Example 6 (cell density: 300 cells/in²). Furthermore, although the operational temperature range of CO oxidation for the catalyst prepared in Example 5, which was prepared by coating a zeolite powder on a honeycomb carrier and then impregnating the carrier with a Pt aqueous solution, was not as good as that of the catalysts from Examples 4 and 6, the catalyst from Example 5 still has a maximum CO conversion of 95%.

The Pt/Y-zeolite catalyst prepared in Example 4 was subjected to a catalyst life test by using a reaction gas consisting of 40% H₂, 20% CO₂, 10% H₂O, 2% CO, 2% O₂, and the balance of N₂, and a flowrate of the reaction gas of 600 cc/min. The results show that the CO conversion of the Pt/Y-zeolite catalyst prepared in Example 4 remains stable without a tendency to decrease during the initial reaction period of 6 hours. This indicated that the catalyst has a high stability.

What is claimed is:

1. A method for removing CO from a hydrogen-rich mixture gas by a selective oxidation, which comprises the following steps:
a) preparing a zeolite catalyst carrying Pt or Ru;
b) flowing a CO-containing hydrogen-rich mixture gas and an oxygen-containing gas through said zeolite catalyst carrying Pt or Ru;
wherein the process of preparing said zeolite catalyst carrying Pt or Ru in Step (a) comprises the following steps:
a1) mixing a zeolite with an aqueous solution containing Pt ions or Ru ions in an amount of said aqueous solution so that said zeolite is subjected to an incipient wetness impregnation, provided that said zeolite is not A-zeolite; and
a2) heating said incipient wetness impregnated zeolite so that only Pt ions or Ru ions in said aqueous solution are deposited to said zeolite.

2. The method as claimed in claim 1, wherein the amount of said aqueous solution in Step (a1) used enables said zeolite to be incipient wetness impregnated with 0.5-5.0 wt % of Pt ions or Ru ions based on the weight of the zeolite.

3. The method as claimed in claim 1, wherein said zeolite in Step (a1) is a Y-zeolite, a ZSM zeolite or a Mordenite zeolite.

4. The method as claimed in claim 3, wherein said zeolite in Step (a1) is a Y-zeolite.

5. The method as claimed in claim 1, wherein the heating in Step (a2) comprises drying said incipient wetness impregnated zeolite at 100-120° C., and calcining said dried zeolite at 400-600° C.

6. The method as claimed in claim 1, wherein said CO-containing hydrogen-rich mixture gas and said oxygen-containing gas in Step (b) has a temperature of 50˜250° C.

7. The method as claimed in claim 1, wherein said CO-containing hydrogen-rich mixture gas in Step (b) is a hydrogen-rich reformate gas obtained by reforming a hydrocarbon, and a hydrogen-rich reformate gas having a reduced CO concentration exiting from said zeolite catalyst carrying Pt or Ru is introduced into a fuel cell.

8. The method as claimed in claim 1, wherein said zeolite catalyst carrying Pt or Ru in Step (b) is surrounded by an atmosphere having a molar ratio of oxygen to CO of 0.5˜2.
